(19) United States
(12) Patent Application Publication
(10) Pub. No.: US 2009/0083732 A1
(43) Pub. Date: Mar. 26, 2009

(54) CREATION AND DEPLOYMENT OF DISTRIBUTED, EXTENSIBLE APPLICATIONS

(75) Inventors: Albert C.S. Shen, Redmond, WA (US); Christopher J. Beiter, Seattle, WA (US); Richard W. Tom, Seattle, WA (US); Ravikumar B. Gopinath, Redmond, WA (US); Brian C. Blomquist, Lynnwood, WA (US); MadhaviLatha Kaniganti, Sammamish, WA (US); David Chiu, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/861,877

(22) Filed: Sep. 26, 2007

(51) Int. Cl. G06F 9/455

(52) U.S. Cl. 717/177

(57) ABSTRACT

Creating a distributed application includes selecting a group of components from a list of components available on a remote server cluster. Data required to install the selected components is received from the remote server cluster. A list of instructions is created in response to the received data. The list of instructions is then stored. The list of instructions is processed to extract the data required to install the selected components. The data required to install the selected components is transmitted to the remote server cluster to enable installation of the components on the remote server cluster.

### BACKGROUND

Software installed over a distributed computing network allows users to create end-to-end applications and solutions that leverage a multitude of services hosted on separate server clusters. These end-to-end applications may contain components such as business data, page designs, page layouts, and business logic, each optionally distributed on different server clusters. Because of the distributed nature of these applications, their deployment poses various difficulties in areas such as coordination, authentication, content fidelity, conflict management, and scalability. For example, as the number of available services grows rapidly, these applications must be extensible in such a way that future services can be easily and flexibly incorporated into the application while maintaining full backwards compatibility with previous applications created.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method of creating a distributed application includes selecting a group of components from a list of components available on a remote server cluster. Data required to install the selected components is received from the remote server cluster. A list of instructions is created in response to the received data and the list of instructions is stored.

A tangible computer-readable medium has computer-executable instructions for creating a distributed application. The instructions include selecting a service from a list of services available on a distributed computer system. A component available on the selected service is selected. Installation data relating to the selected component is received from the distributed computer system. A package file is created in response to the received data. The package file is stored.

A system for centralizing control of a distributed computing application includes a processor and a computer-readable medium. The system also includes an operating environment stored on the computer-readable medium and executed on the processor. Additionally included is a solution framework stored on the computer-readable medium and executed on the processor. The solution framework is configured to select a service from a list of services available on a service cluster. A component available on the selected service is selected. From the selected service, installation data relating to the selected component(s) is received. A package file is created in response to the received data. The package file is then stored on the computer-readable medium.

These and other features and advantages will be apparent from reading the following detailed description and reviewing the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

In the drawings, like numerals represent like elements.

FIG. 1 is a block diagram of an operating environment for implementations of computer-implemented methods as herein described;

FIG. 2 is a block diagram illustrating an operating environment for an implementation of a solution framework;

FIG. 3 is a diagram illustrating an implementation of a package file;

FIG. 4 is a flow diagram illustrating an operation for selecting a group of components;

FIG. 5 is a flow diagram illustrating an operation for creating a package file; and

FIG. 6 is a flow diagram illustrating an operation for deploying a package file on a distributed computing environment.

### DETAILED DESCRIPTION OF IMPLEMENTATIONS

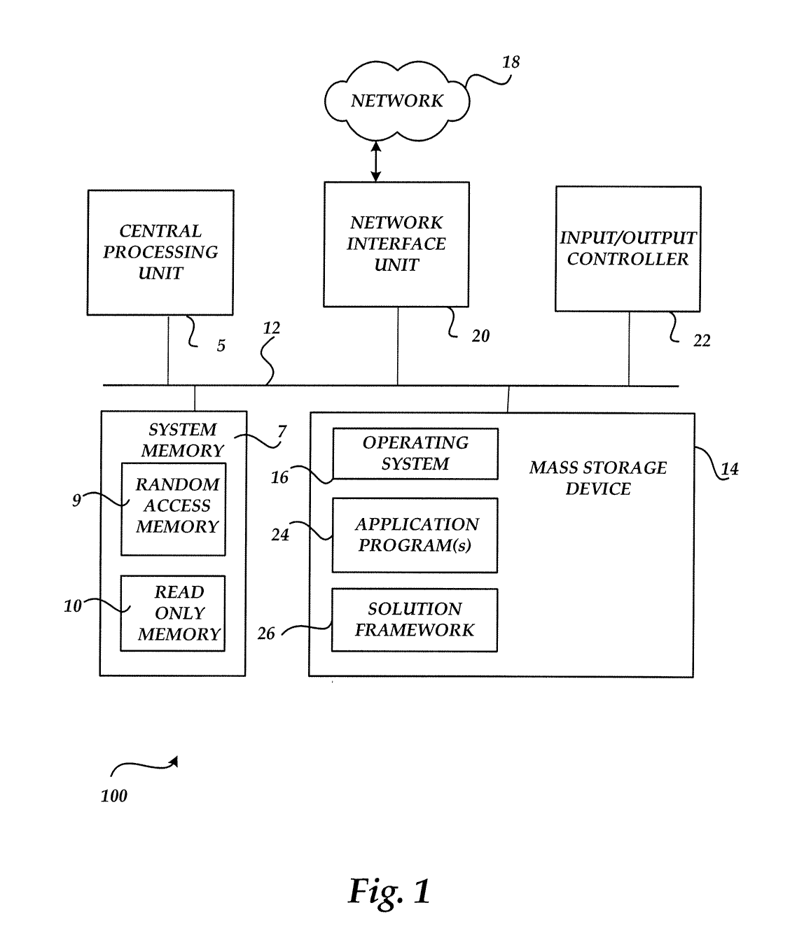

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, a solution framework is provided that is responsible for interfacing between an end-user and service clusters. The solution framework may centralize both the creation and deployment of distributed applications. Many advantages are present in both the creation and the deployment of distributed applications. For example, a distributed application may utilize components on multiple services located on multiple different remote servers in order to combine functionality of the many separate services into a single application.

The solution framework centralizes the creation of a distributed application by acting as an intermediary between a creation user interface and the cluster of services. Before allowing a user to create a package file that integrates a particular service, however, the user may need to be authenticated with the service. The solution framework may also centralize this authentication process by passing user credential information to each of the server clusters. The solution framework may then allow an authenticated user to define a distributed application by selecting various components that are available in the service cluster. In response to the definition of an application, a package file is created. Content fidelity of the package file is maintained through use of watermark metadata that is included within the file based on the contents of the file.

Before the application is installed, the package file may either be transferred from the user defining the application to another user, or simply be installed by the user defining the application. During installation, conflict resolution may also be centrally controlled by the solution framework. Once conflicts are resolved, the solution framework may communicate to all relevant service clusters and install the components in the correct location based upon the defined package file.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 10, and a system bus 12 that couples the memory to the CPU 5.

A basic input/output system containing the basic routines that help to transfer information between elements within the computer, such as during startup, is stored in the ROM 10. The computer 100 further includes a mass storage device 14 for storing an operating system 16, application programs 24, and a solution framework 26, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 28, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS VISTA operating system from MICROSOFT CORPORATION of Redmond, Wash. The mass storage device 14 and RAM 9 may also store one or more program modules. In particular, the mass storage device 14 and the RAM 9 may store one or more application programs 24. For example, the mass storage device 14 may store the solution framework 26. The solution framework 26 centralizes the development and installation of distributed applications.

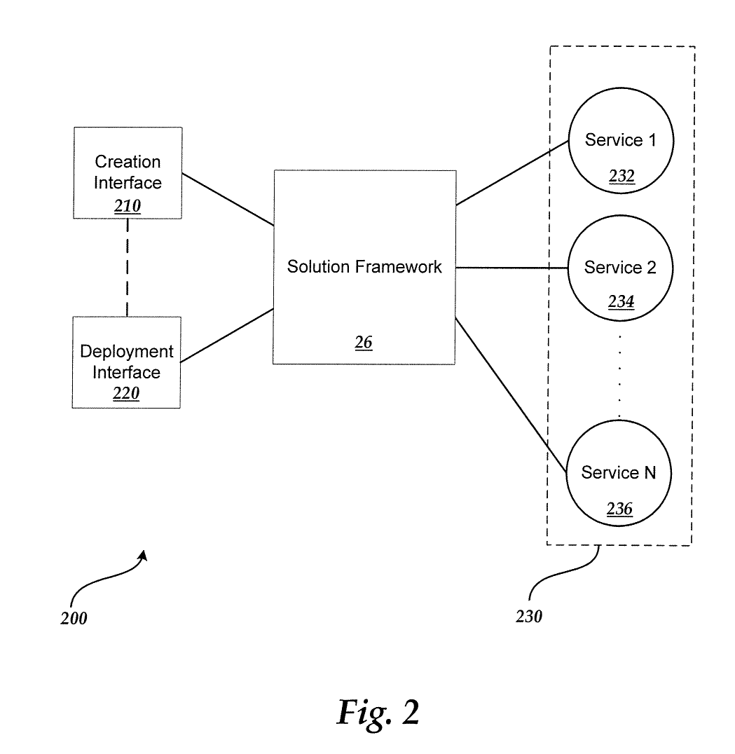

FIG. 2 illustrates an implementation of an environment in which the solution framework 26 operates. The solution frame 26 work may be coupled to a cluster of services 230. The cluster of services 230 may be coupled to the solution framework 26 through a network, such as an internet or an extranet. The cluster of services 230 may include N individual services-services 232, 234 and 236. Individual services may be stored at separate locations. For example, service 230 may be stored on a first server at a first location, and service 240 may be stored on a second server at a second location. In other implementations, multiple services may be stored at a single location. Accordingly, the solution framework may operate independent of the location of the individual services.

Each service may provide various forms of functionality. For example, a service may include business data, page designs or layout. In other examples, a service may include business logic. In still other examples, a service may include any other form of functionality.

The solution framework 26 may also be coupled to a creation interface 210 and a deployment interface 220. The creation interface 210 may provide an interface allowing a user to define a package file that includes a group of selected services. The deployment interface 220 may provide an interface allowing a user to deploy the package file to install the selected group of services. In some implementations these interfaces may be web interfaces coded in a markup language, such as Hypertext Markup Language (HTML) or Extensible Markup Language (XML). In other implementations, these interfaces may be coded in other languages, such as C# or Java.

The creation interface 210 may be located on a first computing environment located at a first location and enable a first user to create a package file while the deployment interface 220 may be located on a second computing environment located at a second location and enabling a second user to deploy the package file. In such an implementation, the package file may be transferred from the first computing environment to the second computing environment. This transfer may be accomplished by any means of file transfer. For example, the file may be encoded on a computer readable medium, such as a disk physically transferred to the second computing environment. In other examples, the file may be electronically transmitted through a network connection between the two computing environment, such as by means of an e-mail attachment sent over an internet.

In other implementations, the creation interface 210 and the deployment interface 220 may be located on the same computing environment. In such an implementation, the same user may both create and deploy the package file from the same computing environment. Further, in such an implementation, the transfer of the package file required above may be avoided.

Accordingly, the solution framework 26 manages and centralizes both the creation of the package file and the deployment of the package file.

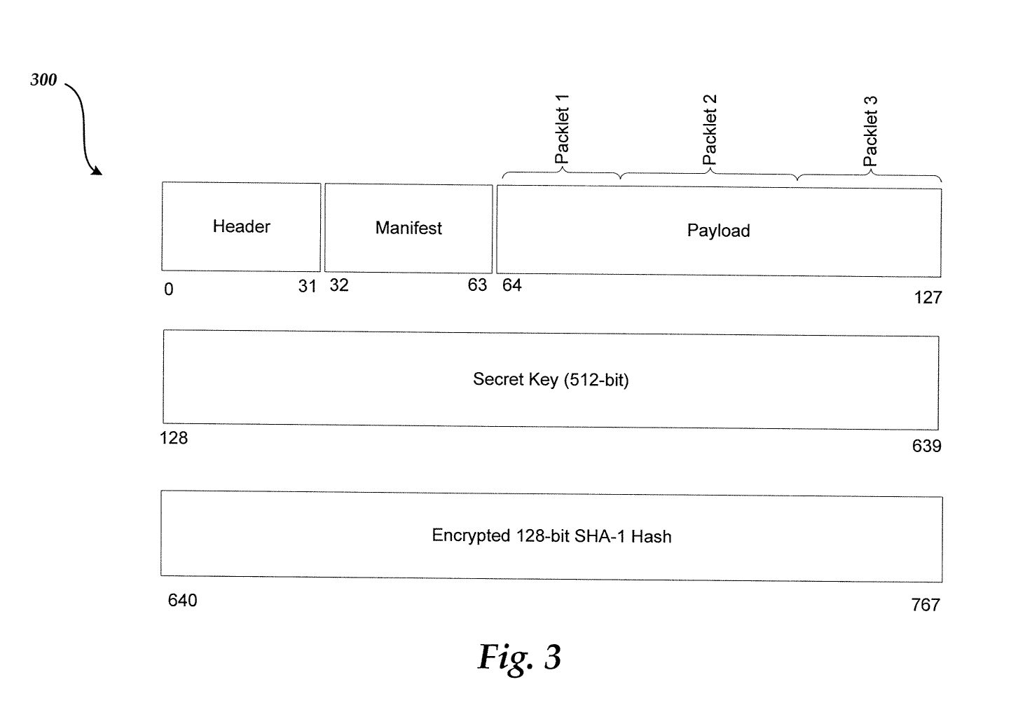

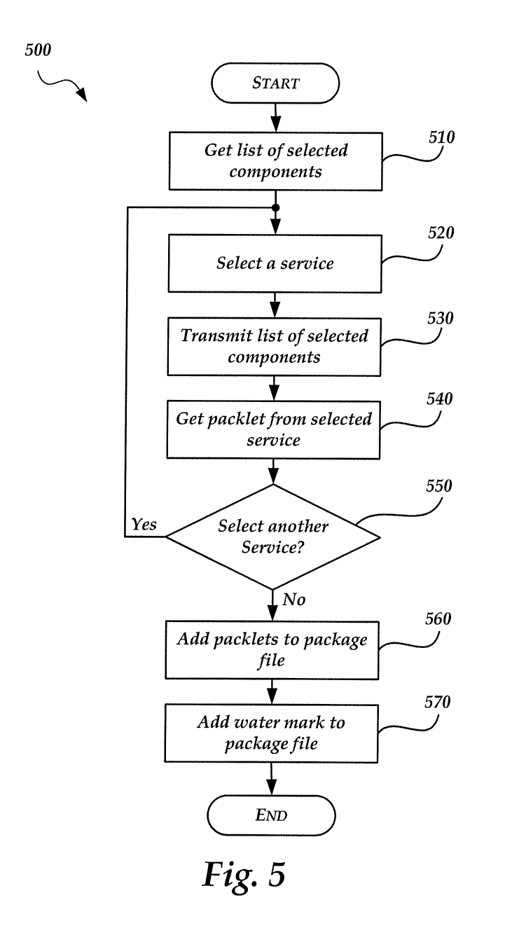

FIG. 3 illustrates an implementation of a package file 300. The package file 300 may include 768 bits, bit 0 through bit 767. The package file 300 may include a header portion at bit 0 through bit 31. The package file 300 may also include a manifest at bit 32 through bit 63 that describes the selected component. The manifest may include information received from the server cluster 230 that describes information about the components that may be used by the services to detect potential conflicts and component availability. For example, the manifest may include a portion of information returned by each service cluster at packlet creation time that describes the components that are in the packlet. The manifest is designed in such as way that, even without the physical packlets, the meta-information in the manifest can be used to detect conflicts. Following the header and manifest, the package file 300 may include a payload at bit 64 through bit 127. As is described in more detail below with reference to FIG. 5, the payload portion of the package file 300 includes information received from the selected services.

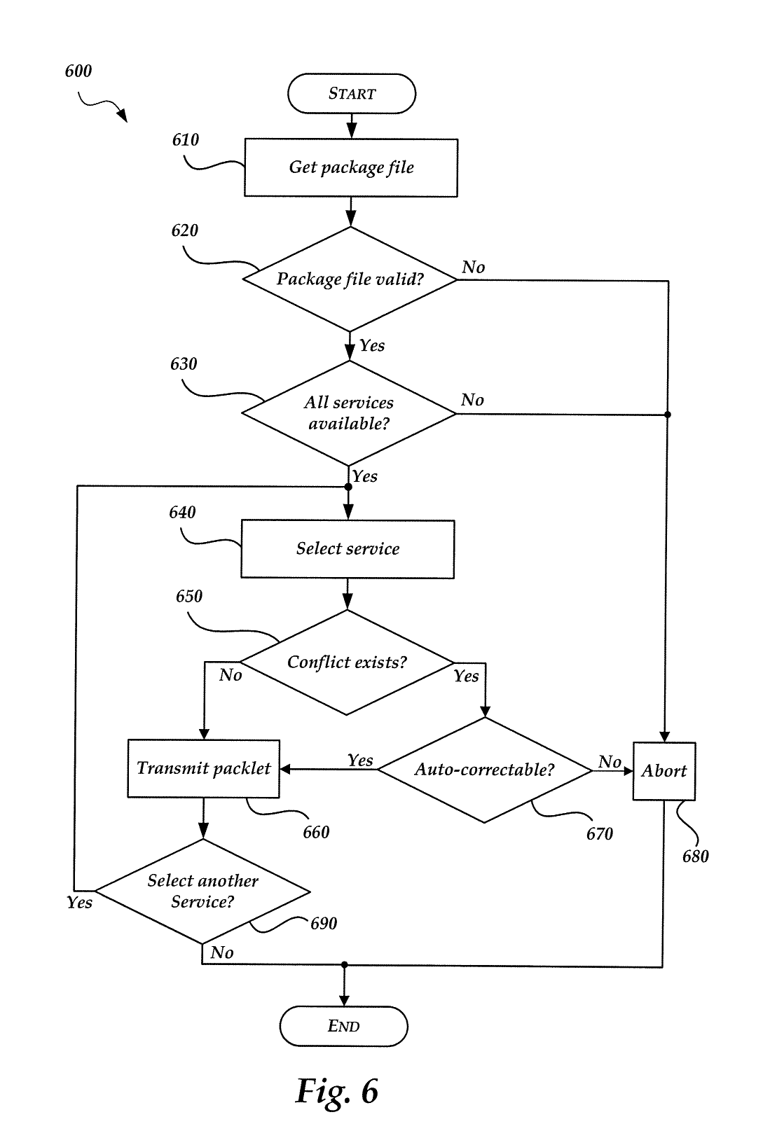

For security, the package file 300 may include a public key, such as a 512-bit Secrete Key, at bit 128 through bit 639. For further security and to enable verification of file integrity, as is described in more detail below with reference to FIG. 6, the package file 300 may include a watermark, such as an encrypted 128-bit Secure Hash Algorithm 5 (SHA-1) hash, at bit 640 through bit 767. In other embodiments the water mark may include a Message-Digest algorithm 5 (MD5) hash. The hash may be created by applying any hashing algorithm to the payload and manifest within the package file.

### Solution Framework Operation

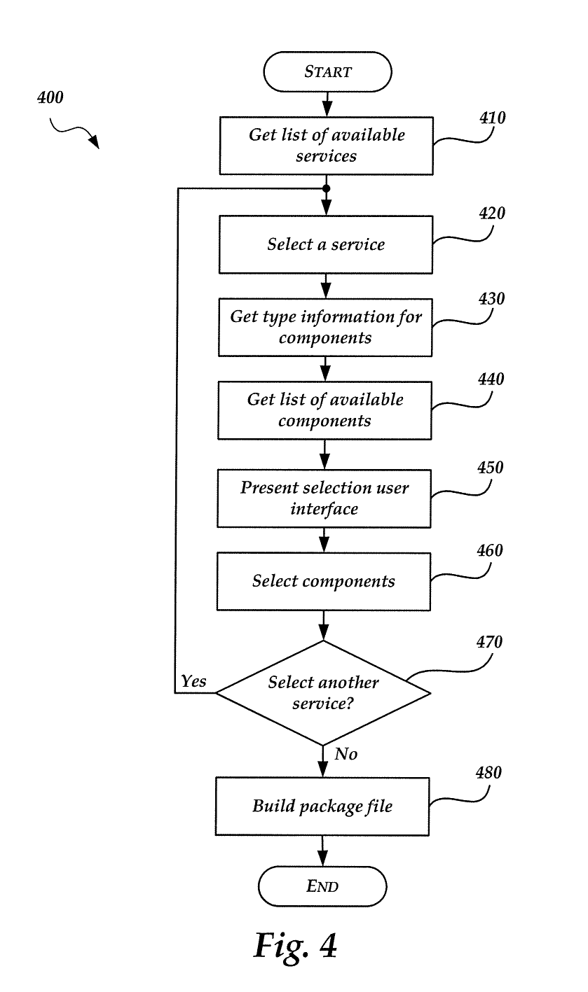

Referring now to FIG. 4, an illustrative process 400 for defining a set of components to be included in a distributed application will be described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to an operation 410 and a list of services is received at the solution framework 26. This process may be triggered, for example, when a user browses to a package creation page on the creation interface 210. The solution framework may then make a call to the service cluster 230 requesting a list of the services available. To determine whether a particular service is available, the solution framework 26 may centrally mediate permissions between the creation interface 210 and each of the services within the service cluster 230. For example, the solution framework 26 may transmit to the service cluster 230 a user's profile and receive, in response, a set of services the user may access. Accordingly, availability may depend upon the services networked to the solution framework 26 as well as individual user permissions.

After the list of available services is received and finalized at the solution framework 26, the process flows to an operation 420, and a first service is selected.

A service may be selected in response to a command to select a service received from the creation interface 210 indicating a user's request to view the components within the service. Once a service is selected, the process flows to an operation 430, where a list of component types is gathered. During this operation, the solution framework 26 communicates to the selected service a request to transmit a list of individual component types available on the selected service. The type information may include information describing the type of components available and information describing a user interface that may be used to select individual components. In some implementations, this information may include custom user interface for selecting the component types and components specific to that service.

The process then flows to an operation 440, where a list of available components is gathered. Similar to the availability of the services described above, the availability of components may depend, not only on whether components are connected to the solution framework 26, but also upon a permission check.

The process then flows to an operation 450 where the type information associated with the selected components received is processed and transmitted to the creation interface 210 where a selection interface is presented to the user. This selection interface is created in response to the type information received from the selected service such that a custom selection interface may be displayed to facilitate selecting the particular type of components available. This custom interface may contain a mechanism for a user to input arbitrary parameters to the selected component. These parameters may act as additional meta-information to describe to the solution framework and the service cluster the manner in which the selected component is to be packaged.

The process then flows to an operation 460, where the user selects the desired components using the selection interface presented on the creation interface 210 of FIG. 2. In some implementations, during this operation, the list of selected components is transmitted to, and received at, the service cluster 230. In other implementations, the list of selected components is not transmitted to the service cluster 230 until the process has been completed for each selected service after operation 470.

Moving to an operation 470, a decision is made as to whether an additional service is selected. If a user selects an additional service, the process returns to the operation 420, and the interface-generation and component-selection process is repeated for the next selected service. If the user does not select an additional service, the process continues to an operation 480.

Continuing to the operation 480, as is described in more detail below with reference to FIG. 5, all of the packlets are combined and formatted into a single package file. The process then flows to an end operation and returns to processing other actions.

Referring now to FIG. 5, an illustrative process 500 for creating a package file, such as that created at operation 480, will be described.

After a start operation, the process flows to an operation 510 and a list of selected components is processed by the solution framework 26. The list of selected components may be received from the creation interface 210 at the solution framework 26. The list of selected components may have been created, for example, in accordance with the process 400 illustrated in FIG. 4.

The process then flows to the operation 520 where a first service in which a selected component is located is selected. This selection is part of an automatic process where the solution framework 26 iterates through all of the services that the components on the list of selected components are included within. Thus, the service may be selected by the solution framework 26 directly, without intervention or input from a user through the creation interface 210. Once the solution framework 26 selects a first service, the process flows to an operation 530 where a description of the components associated with the selected service is transmitted from the solution framework, to the first selected service. That is, the solution framework 26 transmits to the service a list of components located within that service that the user has selected.

Once the service receives the list of components, the process flows to an operation 540 where the service responds to the request by transmitting a packlet containing information associated with the selected components. A packlet may include a binary data stream containing the data requested, as well as a manifest describing meta-information about the data requested.

At an operation 550, a determination is made whether another service is to be selected. If the solution framework 26 has cycled through and processed all of the services needed to process all of the selected components, no further services need be selected and the process continues to an operation 560. If the solution framework 26 has not cycled through all of the services for the selected components, the process returns to the operation 520, and a next service is selected. In other embodiments, this process may be executed asynchronously. That is, a multi-threaded environment where the solution framework 26 simultaneously calls all services to receive packlets and then assembles them as they come back. Thus, this process may be executed in both an asynchronous or linear/sequential manner.

At the operation 560, the received packlets are added into a package file. For example, the packlets may be concatenated together and added into the payload portion of the package file 300. In other implementations, further processing of the packlets may be executed before they are included within the payload of the package file 300.

At an operation 570, a watermark is added to the package file 300. In some implementations, the watermark may simply be a hash created from the packlets. In other implementations, the watermark may be created from the packlets and other data included in the package file, such as a header portion, a manifest portion or a security portion, such as a Secrete Key. In some examples the watermark may be created using an SHA-1 hashing algorithm. Accordingly, the hash may later be used to verify the integrity of the data, included determining whether the package file 300 has been tampered with. The process then flows to an end operation and returns to processing other actions.

Referring now to FIG. 6, an illustrative process 600 for deploying the package file 300 will be described.

After a start operation, the process flows to an operation 610 where the package file 300 is received at the solution framework 26 from the deployment interface 220. In some examples, the package file 300 may be transmitted to the solution framework 26 directly from the system at which it was received during the creation of the package file 300. This may occur in situations where the user that created the package file 300 is also deploying it. In other examples, the package file 300 may be transmitted to the solution framework 26 from a different user. For example, the package file 300 may be received at the creation interface 210 by a first user, and then transported on a compact disc (CD) or sent in an e-mail to a second user at the deployment interface 220, where it is then transmitted to the solution framework 26.

Once the package file 300 has been received at the solution framework 26, the process flows to an operation 620. At the operation 620 a determination whether the package file 300 is valid is made. This determination may be made with reference to the watermark. For example, if the package file 300 has been corrupted during the various transmissions, or the package file 300 has been intentionally tampered with, the watermark may no longer properly match the data contained within the package file 300. In other examples, other criteria may be used to determine whether the package file is valid. For example, reference may be made to whether the file extension has been altered. In other examples, reference may be made to the file size. That is, a default maximum file size may be assigned and anything larger than the default file size may be flagged as invalid. Thus, the determination of whether the package file 300 is valid may partially depend on the water mark and partially depend on other properties of the package file 300. Accordingly, if the package file 300 is valid, the process flows to an operation 630 where processing continues.

If the package file 300 is no longer valid, the process flows to an operation 680 where deployment is aborted and the flow continues to an end operation. In some examples, the abortion operation 680 may include presenting the user with error messages at the deployment interface. In other examples, the abortion operation 680 may also include automatic error correction such that correctable errors are automatically corrected by the solution framework 26 and the process may continue.

At the operation 630, the package file 300 is processed and the payload extracted. The payload is processed to determine which services are required. The solution framework 26 then determines whether all of the services required by the package file are available. If a component that is included within the package file 300 resides on a particular service, that service is required. For example, if time has passed between when the package file 300 was created and when the package file 300 is being deployed, one or more of the services available in the service cluster 230 may longer be available.

As described above, a service may also no longer be available if, for example, the user deploying the package file 300 does not have permission to access a particular service, or if the service has simply been disconnected from the network. If a required service is not available, the process flows to the operation 680 where the deployment is aborted. If all of the required services are available, the process flows to an operation 640.

At the operation 640, a first service is selected. This selection is part of an automatic process where the solution framework 26 iterates through all of the services utilized by the components in the payload of the package file 300. Thus, the service may be selected by the solution framework 26 directly, without intervention or input from a user through the deployment interface 220. Once the solution framework 26 selects a first service, the process flows to an operation 650 where a conflict check is executed.

At the operation 650, content of the package file 300 may be transferred to the service cluster 230. In some implementations, only the manifest may be transmitted to save costly transmission time. The manifest may include a portion of information returned by each service cluster at packlet creation time that describes the components that are in the packlet. The manifest is designed in such as way that, even without the physical packlets, the meta-information in the manifest can be used to detect conflicts. Each service then inspects the content of the package file 300 (or manifest in other implementations) and reports to the solution framework 26 component details, component conflicts, and any other deployment issues that the user may encounter during the deployment of the package file 300. By reporting this information back to the solution framework 26, control of the conflict checking process may be centralized. If a conflict exists, the process flows to an operation 670. If no conflicts exist, the process flows to an operation 660 and the deployment process continues. In other embodiments, the process of conflict checking may be executed asynchronously. That is, a multi-threaded process where the solution framework 26 simultaneously detects conflicts. Thus, this process may be executed in both an asynchronous or linear/sequential manner.

At the operation 670, a determination is made whether the conflict may be automatically correct by the solution framework. If the solution framework can automatically correct a conflict, the solution framework may then automatically correct the conflict and the process can continue to the operation 660. In some implementations, a warning message may be presented to the user through the deployment interface 220 to inform the user of the conflict that was corrected. If the solution framework 26 cannot automatically correct the conflict, an error message may be presented to the user indicating the fatal conflict, and the process flows to the operation 680 where the deployment is aborted. In still other implementations, the user may be given the ability to automatically override any conflicts to overwrite conflicting components. In such implementations, the user may need to do this before attempting to deploy the package file 300 and if a conflict occurs, the components my be overwritten with the new components from the package file 300.

At the operation 660, the components of the selected service are deployed by transmitting the packlets relating to the selected components to the service. Each packlet may include a series of binary data specific to the service. The selected service may know how to de-serialize the data stream back into relevant data for deployment. Once the data is deployed on the service, the process continues to operation 690.

At the operation 690, a determination of whether another service is to be selected is made. If additional components must be deployed on another service, the process returns to the operation 640, and a next service is selected. If all of the components have been deployed, the process flows to an end operation.

In other implementations, all of the selected components may be processed to check for conflicts before any packlets are transmitted from the solution framework 26 to the service cluster 230. For example, all of the services may be cycled through, the conflict information gathered at the solution framework where it is centrally processed, and if the conflicts are cleared the packlets then transmitted to the service cluster 230. In the way, all of the conflicts may be centrally handled.

Further, a post deployment process may be executed. For example, after deploying a packlet, each service cluster may report information about the components there were deployed. This post-deployment information may then be communicated back to each service cluster. Thus, all of the service clusters are once again communicated with after the deployment of the entire package is complete. This allows the service clusters to be informed about all the components that were deployed across the entire system. In this manner, each cluster to may execute post-deployment operations based on that information. For example, components in a first service cluster and a second service cluster may be very closely related to one another, and by knowing the final deployment information related to each other, the services may execute business logic that reinforces the fact that this is the deployment of an end-to-end, closely-tied distributed application rather than a many segregated pieces.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of creating a distributed application, comprising:
selecting a group of components from a list of components available on a remote server cluster;
receiving from the remote server cluster data required to install the selected components;
creating a list of instructions n response to the received data; and
storing the list of instructions.

2. The method of claim 1, wherein the storing the list of instructions further includes:
encoding the received information in the list of instructions; and
encoding a watermark in the list of instructions.

3. The method of claim 1, wherein the selecting a group of components from a list of components available on a remote server cluster further includes:
selecting a service available on the remote server cluster;
receiving a list of components available on the selected service; and
selecting a component available on the selected service.

4. The method of claim 3, wherein the selecting a component available on the selected service further includes receiving selection interface data specific to the type of component available on the selected service.

5. The method of claim 1, further comprising:
processing the list of instructions e to extract the data required to install the selected components; and
transmitting the data required to install the selected components to the remote server cluster to enable installation of the components on the remote server cluster.

6. The method of claim 5, wherein the processing the list of instructions further includes:
transmitting a description of the selected components to services associated with the selected components;
receiving conflict information from the services;
centrally processing the conflict information to determine whether a conflict exists within the selected components; and
when a conflict does not exist, transmitting the data required to install the selected components to the remote server cluster to enable installation of the components on the remote server cluster in response to the centrally processing the conflict information.

7. The method of claim 6, wherein the processing the list of instructions further includes:
when a conflict does exist, determining whether the conflict may be automatically handled; and
automatically handling a conflict in response to the determination of whether the conflict may be automatically handled.

8. A tangible computer-readable medium having computer-executable instructions for creating a distributed application, the instructions comprising:
selecting a service from a list of services available on a distributed computer system;
selecting a component available on the selected service;
receiving from the distributed computer system installation data relating to the selected component;
creating a package file in response to the received data; and
storing the package file.

9. The computer-readable medium of claim 8, wherein the storing the package file further includes:
encoding a manifest describing the selected component in the package file;
encoding as a payload the installation data in the package file; and
encoding a watermark in the package file.

10. The computer-readable medium of claim 9, wherein the encoding the watermark in the package file further includes creating an encrypted hash of data included in the package file.

11. The computer-readable medium of claim 8, wherein the selecting a component available on the selected service further includes:
receiving selection interface data specific to a type of component available on the service; and
passing the selection interface data to a deployment interface for generation of a selection interface in response to the selection interface data.

12. The computer-readable medium of claim 8, further comprising:
processing the package file to extract the installation data; and
transmitting the installation data to the distributed computer system to enable installation of the distributed application.

13. The computer-readable medium of claim 9, wherein the processing the package file further includes:
transmitting the manifest to the selected service associated with the selected component;
receiving conflict information from the selected service;
centrally processing the conflict information to determine whether a conflict exists; and
transmitting the installation data to the selected service to enable installation of the distributed application in response to the centrally processing the conflict information.

14. The computer-readable medium of claim 12, wherein the processing the package file further includes:
determining whether the selected service is available; and
transmitting the installation data to the distributed computer system to enable installation of the distributed application when the selected service is available.

15. The computer-readable medium of claim 12, wherein the processing the package file to extract the installation data further includes:
determining whether the selected component is available based on user permissions; and
transmitting the installation data to the distributed computer system to enable installation of the distributed application when the selected component is available.

16. A system for centralizing control of a distributed computing application, comprising:
a processor and a computer-readable medium;
an operating environment stored on the computer-readable medium and executed on the processor; and
a solution framework stored on the computer-readable medium and executed on the processor and is configured to:
select a service from a list of services available on a service cluster;
select a component available on the selected service;
receive from the selected service installation data relating to the selected component;
create a package file in response to the received data; and
store the package file on the computer-readable medium.

17. The system of claim 16, wherein the solution framework is further configured to store the package file on the computer-readable medium by:
storing a manifest describing the selected component in the package file;
storing the installation data in the package file; and
storing a watermark in the package file.

18. The system of claim 16, wherein the solution framework is further configured to:
receive a custom selection interface specific to a type of component available on the service; and
pass the custom selection interface to a deployment interface.

19. The system of claim 17, wherein the solution framework is further configured to:
process the package file to extract the installation data; and
transmit the installation data to the distributed computer system to enable installation of the distributed computing application.

20. The system of claim 19, wherein the solution framework is further configured to process the package file to extract the installation data by:
transmitting the manifest to the selected service associated with the selected component;
receiving conflict information from the service;
centrally processing the conflict information to determine whether a conflict exists;
transmitting the installation data to the selected service to enable installation of the components in response to the centrally processing the conflict information; and
transmitting a post-deployment call to the service cluster.
